(19) United States
(12) Patent Application Publication
(10) Pub. No.: US 2016/0104391 A1
(43) Pub. Date: Apr. 14, 2016

(54) METHOD OF TRAINING AN OPERATOR OF MACHINE

(71) Applicant: Caterpillar Inc., Peoria, IL (US)

(72) Inventors: Nathan J. Wieland, Eureka, IL (US); Benjamin J. Hodel, Dunlap, IL (US); Eric W. Cler, Oswego, IL (US); Aaron R. Shatters, Montgomery, IL (US); Jeffrey K. Berry, Yorkville, IL (US)

(73) Assignee: Caterpillar Inc., Peoria, IL (US)

(21) Appl. No.: 14/972,118

(22) Filed: Dec. 17, 2015

(51) Int. Cl. G09B 19/00; G09B 19/24; G09B 5/02

(52) U.S. Cl. CPC G09B 19/003; G09B 5/02; G09B 19/24

(57) ABSTRACT

A method for generating a training plan for an operator of a machine to perform an operation is provided. The method includes receiving data associated with one or more functional parameters of the machine. The functional parameters include at least one of an operation parameter, an operator attribute parameter, and an environmental parameter. The method includes identifying a value of each of the functional parameters based on the data. Further, the method includes determining, in real-time, the training plan based on the identification of the functional parameters. The method includes communicating the instruction to the operator for performing the operation on the machine based on the training plan. The method includes monitoring the operation for being in conformance with the training plan. The method includes generating an alarm, when the operation performed by the operator deviates from the instructions of the training plan.

### TECHNICAL FIELD

The present disclosure relates to a method of training an operator of a machine, and more specifically to the method for generating, in real-time, a training plan for the operator to perform an operation on the machine.

### BACKGROUND

Machines, such as a wheel loader, a track-type tractor, a motor grader, an excavator, an articulated truck, or any other earthmoving machine require a skilled operator for performing various operations. For each operation, a machine may need to be operated in an appropriate manner to improve performance, fuel efficiency, and/or machine longevity. Therefore, operators of such machines require undergoing extensive training in order to operate the machine.

As per conventional techniques, the operator is trained for operating the machine by generating a training plan. The training plan is used for training the operator to perform an operation based on a predefined mode of performing the operation. The predefined mode may be understood as a “best mode” of performing the operation. The training plan is developed for correcting deviations from the predefined “best mode”. Therefore, the conventional techniques are modeled based on such “best modes”, and do not consider several other real-time factors, such as soil conditions, weather at a worksite, and an operator style, for generating the training plan. Thus, the existing techniques are fragmented in nature and consequently, an accuracy of the training plan is compromised. Also, the conventional techniques do not allow real-time updating or modification of the training plan, for accommodating a change in any factor associated with the operation. Moreover, the generation of the training plan usually occurs in an on-board manner or an off-board manner. The on-board generation of the training plan involves installation of equipment, for example, a data analyzing unit on the machine resulting into an undesirable increase in the weight and complexity of the machine. On the other hand, in case of the off-board generation of the training plan, the overall processing is hampered due to a time lag in exchanging data between the machine and off-site equipment.

WIPO Patent Publication Number 2014/042572 A1, hereinafter referred to as '572 application, describes a method for providing a coaching message to a driver of a vehicle for encouraging a desired driving behavior of the vehicle. The coaching message is provided by a coaching arrangement comprised with the vehicle. The method includes determining a driving context for the vehicle. The method further includes determining a coaching level for the driving context. Furthermore, the method includes selecting the coaching messages to be provided to the driver using a multimodal user interface of the coaching arrangement based on a correlation of the determined coaching level and the determined driving context. However, the '572 application follows a fragmented and complicated approach for coaching the operator of the vehicle.

### SUMMARY OF THE DISCLOSURE

In one aspect of the present disclosure, a method for generating a training plan for an operator of a machine to perform an operation is provided. The method includes receiving, by a controller, data associated with one or more functional parameters of the machine. The functional parameters include at least one of an operation parameter, an operator attribute parameter, and an environmental parameter. The operation parameter, the operator attribute parameter, and the environmental parameter are indicative of an identification of the operation to be performed and an operational mode of the machine, an operating style of the operator, and an environmental condition, respectively. The method also includes identifying a value of each of the functional parameters based on the data. The method further includes determining, in real-time, the training plan based on the identification of the functional parameters. The training plan includes instructions for the operator to perform the operation. The method includes communicating the instructions to the operator for performing the operation on the machine based on the training plan. The method also includes monitoring the operation for being in conformance with the training plan. The method further includes generating an alarm when the operation performed by the operator deviates from the instructions of the training plan.

Other features and aspects of this disclosure will be apparent from the following description and the accompanying drawings.

### BRIEF DESCRIPTION OF THE DRAWINGS

FIG. 1 is side view of an exemplary machine, in accordance with concepts of the present disclosure;

FIG. 2 is a block diagram of an operator training system for training an operator of the machine of FIG. 1, in accordance with the concepts of the present disclosure;

FIG. 3 is a controller of the operator training system of FIG. 2, in accordance with the concepts of the present disclosure; and

FIG. 4 is a flowchart depicting a method for generating a training plan for training the operator of the machine of FIG. 1, in accordance with the concepts of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

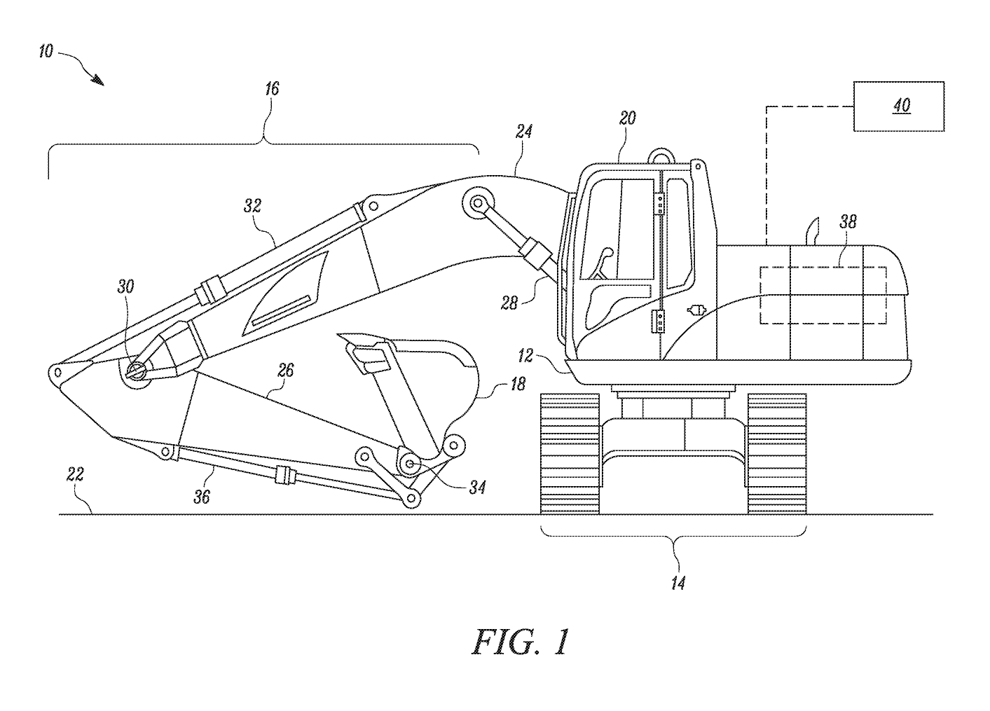

Referring to FIG. 1, the machine 10 is embodied as an excavator. It should be noted that the machine 10 of the present disclosure may be replaced with any other industrial machine, such as a track-type tractor, a wheel loader, an articulated truck, a motor grader, a pipe layer, a backhoe, or any other construction machine known in the art, without departing from the scope of the present disclosure.

The machine 10 includes a frame 12, a number of ground engaging members 14 for propelling the machine 10, a linkage system 16 coupled to the frame 12, a tool 18 coupled to the linkage system 16, and an operator station 20 for accommodating an operator. The ground engaging members 14 include a pair of tracks which are in contact with a ground surface 22 for moving the machine 10 on the ground surface 22.

The linkage system 16 includes a boom member 24 pivotally connected to the frame 12 of the machine 10 and a stick member 26 pivotally connected to the boom member 24. The boom member 24 is configured to vertically pivot about a first horizontal axis (not shown) relative to the ground surface 22 by a pair of first hydraulic actuators 28. Similarly, the stick member 26 is configured to vertically pivot about a second horizontal axis 30 by a second hydraulic actuator 32. The stick member 26 is further connected to the tool 18 that is configured to vertically pivot about a third horizontal axis 34 by a third hydraulic actuator 36.

The machine 10 includes an engine (not shown) enclosed in an engine compartment 38 to provide power to a main drive system (not shown) and the linkage system 16 for moving the machine 10 and the tool 18, respectively. Further, the operator station 20 accommodates the operator to control operations of the machine 10. The operator station 20 includes a number of control equipment (not shown) to control the operations of the machine 10.

The machine 10 further includes an operator training system 40. The operator training system 40 generates a training plan for training or coaching the operator to perform one or more operations on the machine 10. In one example, the operation may include, but is not limited to, a digging operation, a dumping operation, a swinging operation, a loading operation, and a lifting operation. The term “training plan” referred to herein may be defined as a set of instructions provided to the operator for performing a specific operation on the machine 10.

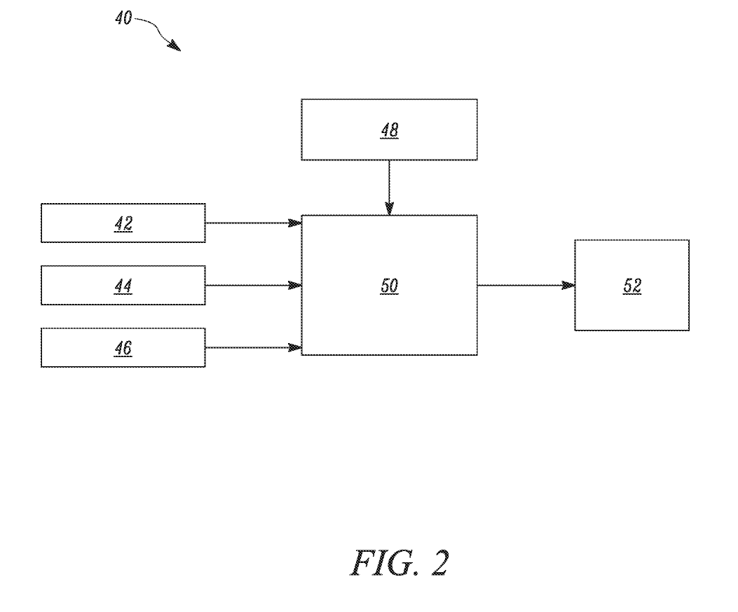

FIG. 2 is a block diagram of the operator training system 40 for training the operator of the machine 10. The operator training system 40 includes an operation sensing unit 42, an operator attribute sensing unit 44, an environment sensing unit 46, an operator interface 48 for controlling the machine 10, a controller 50 for determining the training plan in real-time, and an output unit 52 for forwarding information to the operator. The operation sensing unit 42, the operator attribute sensing unit 44, and the environment sensing unit 46 detect real-time data associated with functional parameters of the machine 10.

The functional parameters include at least one of an operation parameter, an operator attribute parameter, and an environmental parameter. The operation parameter is indicative of an identification of the operation to be performed and an operational mode of the machine 10. The operator attribute parameter is indicative of an operating style of the operator. Further, the environmental parameter is indicative of an environmental condition around the machine 10.

The operation sensing unit 42 detects data associated with the operation parameter. In one example, the operation parameter may include, but is not limited to, a tool position, a load pressure, an actuator displacement, machine acceleration, a wheel speed, and a fuel level. For detecting the data associated with the operation parameter, the operation sensing unit 42 includes a first set of sensors. The first set of sensors may include, but are not limited to, a tool position sensor, a load pressure sensor, an inertial measurement sensor, and a fuel level sensor.

The operator attribute sensing unit 44 detects data associated with the operator attribute parameter. In one example, the operator attribute parameter may include, but is not limited to, a movement of the operator's feet on pedals, a steering wheel rotation, a frequency of gear shifting, and a movement of joystick. For detecting the data associated with the operator attribute parameter, the operator attribute sensing unit 44 includes a second set of sensors. The second set of sensors may include, but are not limited to, a steering wheel sensor, a gear position sensor, and a seat sensor.

In one example, the data associated with the operation parameter and the operator attribute parameter may be detected by a common set of sensors. The common set of sensors may be a combination of the first set of sensors and the second set of sensors working in conjunction with each other. The common set of sensors may detect the data associated with the operation parameter during a predefined time duration. Further, characteristics of the data associated with the operation parameter detected over the predefined time duration may then be used for determining the data associated with the operator attribute parameter. Such characteristics may include, but are not limited to, a frequency of occurrence of operations, a transition period between subsequent occurrence of the operations, and a variety of operations performed during the predefined time duration. In one example, the characteristics may also be determined based on a chronological set of data detected by the common set of sensors. Therefore, based on the sequence of detection of the data associated with the operation parameter, the data associated with the operator attribute parameter may be determined.

The environment sensing unit 46 detects data associated with the environmental parameter. In one example, the environmental parameter may include, but is not limited to, a weather condition, a wind speed, humidity, a wind direction, a pressure, and a temperature of the work site. For detecting the data associated with the environmental parameter, the environment sensing unit 46 includes a third set of sensors. The third set of sensors may include, but are not limited to, a temperature sensor, a pressure sensor, a wheel speed sensor, a humidity sensor, a wind sensor, rain intensity sensor, and a wind direction sensor. In one example, the environment sensing unit 46 may be a meteorological system for monitoring weather conditions. In another example, the environment sensing unit 46 may include a remote database that stores real-time information associated with local weather conditions.

The operator interface 48 may include, but is not limited to, a steering wheel, pedals, keyboards, and display units. In one example, the operator interface 48 may be present within the operator station 20 of the machine 10. The operator interface 48 enables the operator to interact with the operator training system 40 and to control the operation of the machine 10. The operator interface 48 also enables the operator to input the data associated with the operation parameter, the operator attribute parameter, and the environmental parameter to the operator training system 40, which is otherwise detected by the operation sensing unit 42, the operator attribute sensing unit 44, and the environment sensing unit 46, respectively. In one example, the operator may input the data indicative of one or more of the operation parameter, the operator attribute parameter, and the environmental parameter to the operator training system 40 by using the operator interface 48, for e.g., a keyboard or a touch-sensitive display unit.

The operation sensing unit 42, the operator attribute sensing unit 44, the environment sensing unit 46, and the operator interface 48 are in operable communication with the controller 50. The controller 50 receives the data associated with the operation parameter, the operator attribute parameter, and the environmental parameter from the operation sensing unit 42, the operator attribute sensing unit 44, and the environment sensing unit 46, respectively. The controller 50 may also receive the data pertaining to the operational mode of the machine 10 associated with the operation parameter from the operator through the operator interface 48. Based on the data received from the operation sensing unit 42, the operator attribute sensing unit 44, the environment sensing unit 46, and the operator interface 48, the controller 50 determines the training plan. The training plan includes one or more instructions for training the operator to perform the operation on the machine 10.

The controller 50 is further in operable communication with the output unit 52. The output unit 52 communicates the instructions to the operator for performing the operation, based on the training plan determined by the controller 50. The output unit 52 may include an audio device, a video device, a haptic device, or a combination thereof, for communicating the instructions to the operator for performing the operation. In one example, the output unit 52 may include, but is not limited to, a display screen and a speaker.

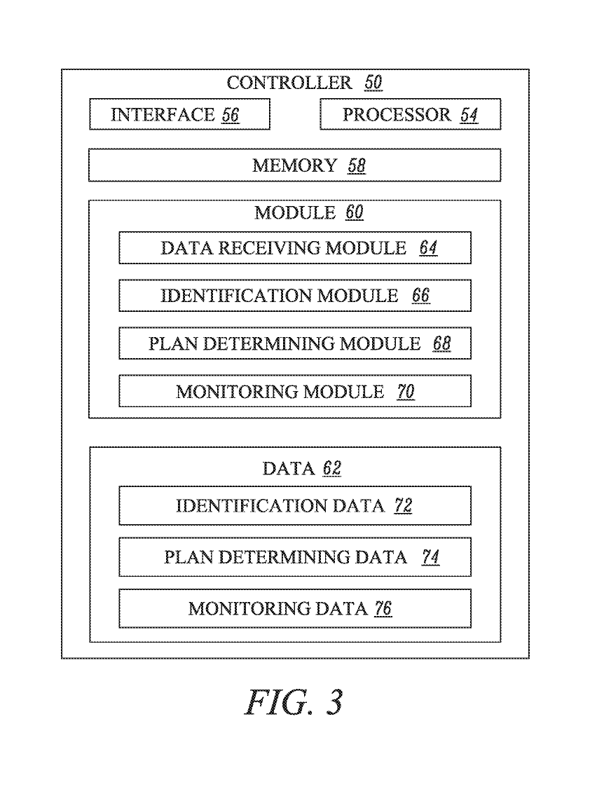

Referring to FIG. 3, the controller 50 is configured to determine the training plan for the operator to perform the operation. The controller 50 includes a processor 54, an interface 56, and a memory 58 coupled to the processor 54. The processor 54 is configured to fetch and execute computer readable instructions stored in the memory 58. The interface 56 facilitates multiple communications within wide variety of protocols and networks, such as network, including wired network. In one example, the interface 56 may include one or more ports for connecting the controller 50 to the output unit 52.

The controller 50 also includes modules 60 and data 62. The modules 60 include routines, programs, objects, components, data structures, etc., which perform particular tasks or implement particular abstract data types. In one embodiment, the modules 60 include a data receiving module 64, an identification module 66, a plan determining module 68, and a monitoring module 70. The data 62 inter alia includes repository for storing data processed, received, and generated by one or more of the modules 60. The data 62 includes an identification data 72, a plan determining data 74, and a monitoring data 76.

The data receiving module 64 receives the data pertaining to the operation parameter, the operator attribute parameter, and the environmental parameter detected by the operation sensing unit 42, the operator attribute sensing unit 44, and the environment sensing unit 46 of the operator training system 40, respectively. In one example, details pertaining to the data receiving module 64 may be stored in the identification data 72.

Based on the data received by the data receiving module 64, the identification module 66 identifies a value of each of the functional parameters of the machine 10. The identification module 66 identifies a value of the operation parameter. The value of the operation parameter represents a type of operation to be performed by the operator and an operational mode of the machine 10 for performing the operation. The type of operation may include, but is not limited to, a digging operation, a dumping operation, a loading operation, a drilling operation, and a paving operation. The operational mode may include, but is not limited to, a “production-optimizing mode”, a “time-optimizing mode”, a “fuel-efficiency mode”, and a “durability-optimizing mode”.

In one example, the identification module 66 programmatically determines the value of the operation parameter, more specifically, the value of the operational mode by extracting a set of parameters related to the operational mode from the data received from the data receiving module 64. The set of parameters may be scaled and reduced to a set of dimensionally reduced parameters by data reduction methods, such as a principle component analysis. The principle component analysis is a statistical procedure for converting a set of observations of possibly correlated variables into a set of values of linearly uncorrelated variables. The identification module 66 compares the set of dimensionally reduced parameters to a predefined set of parameters indicative of different operational modes. Based on the comparison, the identification module 66 determines the value of the operational mode. The comparison of the set of dimensionally reduced parameters and the predefined set of parameters is performed by using methods, such as Euclidean distance method. The Euclidean distance method is used to calculate a distance, more specifically, similarity between two values in Euclidean space.

In one example, the identification module 66 may identify the operational mode, based on an input provided by the operator through the operator interface 48. In another example, the identification module 66 may identify the operational mode, based on an input provided by a site manager located a remote location. In such an example, the operator interface 48 may be located at the remote location through which the site manager may provide the input pertaining to the operational mode by using a remote device (not shown). The remote device may include, but is not limited to, a laptop, a tablet, a mobile phone or any wireless device known in the art.

In one example, the operator performs the digging operation on the machine 10 for removing soil from a dig location to form a trench. Further, the identification module 66 identifies the value of the operation parameter being indicative of the operational mode as “time-optimizing mode”, based on the data received by the data receiving module 64, via the operator interface 48. In such an example, the identification module 66 identifies the value of the operation parameter as “Digging operation” and “time-optimizing mode”.

In another example, the operator swings the linkage system 16 from the dig location to a dump location for dumping the soil at the dump location. Further, the identification module 66 identifies the value of the operation parameter being indicative of the operational mode as “fuel-efficiency mode”. In such a case, the identification module 66 identifies the value of the operation parameter as “Dumping operation” and “fuel-efficiency mode”, based on the data detected by a tool position sensor and the data received from the operator through the operator interface 48 of the operator training system 40.

In yet another example, the operator may operate the machine 10 to load a truck with a loose stockpile of rock and dirt located at a worksite (not shown). In such a case, the identification module 66 identifies the value of the operation parameter being indicative of the type of operation as “Loading operation”.

The identification module 66 further identifies the value of the operator attribute parameter. The value of the operator attribute parameter represents an operating style of the operator of the machine 10. The identification module 66 identifies the operator style based on the inputs received from the operator attribute sensing unit 44. For example, to perform the “Dumping operation”, the operator is swinging the linkage system 16 at a speed that is more than a permissible speed limit value. In such an example, the identification module 66 identifies the operating style of the operator as “aggressive”. In another example, when the operator is driving the machine 10 down a slope at a high speed, the identification module 66 identifies the operating style of the operator as “aggressive”. In yet another example, the operator drives the machine 10 too close to an edge of the trench while performing the “Digging operation”. In such an example, the identification module 66 identifies the operating style of the operator as “careless”.

In another example, the operator may perform the “Loading operation” by using a loading technique in which the operator places the machine 10 at a 45-degree angle to a load area and moves the machine 10 in a V-pattern between the load area and the truck to be loaded. In such an example, the identification module 66 identifies the operating style of the operator as “tight V-pattern”. In yet another example, the operator may perform the “Loading operation” by using a ‘long load and carry” loading technique. In such an example, the identification module 66 identifies the operating style of the operator as “long load and carry”.

Furthermore, the identification module 66 identifies the value of the environmental parameter. The value of the environmental parameter represents an environmental condition of a worksite. For example, the environment sensing unit 46 detects rain drops and an increase in humidity. In such an example, the identification module 66 identifies the value of the environmental parameter as “Rainy” condition. In one example, if the operator is performing the operator on the worksite with insufficient natural lighting or poor visibility condition, the identification module 66 identifies the value of the environmental parameter as “low visibility”. In another example, the identification module 66 identifies the value of the environmental parameter in terms of a soil quality of a dig location. In one example, details pertaining to the identification module 66 may be stored in the identification data 72.

Based on the identification of the functional parameters, the plan determining module 68 determines the training plan. In one example, the identification module 66 identifies the value of the operation parameter as the “Dumping operation” and “time-optimizing mode”, the operator attribute parameter as “aggressive”, and the environmental parameter as “low visibility”. In such an example, the training plan includes the instructions for training the operator to maintain a constant angle between the boom member 24 and the stick member 26, to reduce unnecessary movements in the linkage system 16 while performing the “Dumping operation”. Further, the training plan may include instructions for training the operator to perform the operation at high speed, thereby consuming less amount of time for completing the operation. The training plan may also instruct the operator to swing the linkage system 16 at a speed below the permissible speed limit value, while performing the “Dumping operation”. Furthermore, the training plan may also instruct the operator to turn-on an auxiliary lighting system for improving the visibility on the worksite. In another example where the operational mode may be the “fuel-efficiency mode”, the training plan guides the operator to accelerate and/or de-accelerate the machine 10 in an effective manner, thereby optimizing the fuel consumption.

In one example, the plan determining module 68 considers the correlation between the detected functional parameters of the machine 10, for generating the training plan. For example, if the identification module 66 identifies the value of the operational mode as the “time-optimizing mode”, the plan determining module 68 may generate a training plan to train the operator for aggressively operating the machine 10 so as to complete the operation in a time-efficient manner. In such an example, the training plan may also guide the operator to maintain the aggressive operating style that is suitable to perform the operation in the “time-optimizing mode”. In the present disclosure, the operator training system 40 is a closed-loop and a context-based system. The training plan determined by the plan determining module 68 may be updated based on any change detected in the values of the operation parameter, the operator attribute parameter, and the environmental parameter. The operation sensing unit 42, the operator attribute sensing unit 44, and the environment sensing unit 46 detect the operation parameter, the operator attribute parameter, and the environmental parameter in real-time, respectively. In one example, the identification module 66 identifies a change in the value of the operational mode of the operation parameter from the “fuel-efficiency mode” to the “time-optimizing mode”. In such a situation, the plan determining module 68 updates the training plan to instruct the operator for performing the operation in the time-efficient manner. Therefore, as the context of the operation sensing unit 42, the operator attribute sensing unit 44, and the environment sensing unit 46 changes, the operator training system 40 updates the training plan accordingly. In one example, details pertaining to the plan determining module 68 may be stored in the plan determining data 74.

Following the generation of the training plan, the monitoring module 70 monitors whether the operation of the machine 10 conforms to the training plan. When the operation performed by the operator deviates from the training plan, the monitoring module 70 generates an alarm. In order to determine any deviation from the training plan, the monitoring module 70 may detect the movement and position of various components of the machine 10 while the operation is under progress. For example, the monitoring module 70 may monitor data pertaining to the position and movement of the components received in real-time from the operation sensing unit 42, the operator attribute sensing unit 44, and the environment sensing unit 46. If the determined position and movement of the components deviate from expected position and movement based on the training plan, the monitoring module 70 may generate the alarm notifying the operator of the deviation.

In one example, the alarm generated by the monitoring module 70 may be an audible message transmitted to the operator via an audio device integrated to the output unit 52. In another example, the alarm generated by the monitoring module 70 may be a visual message transmitted to the operator, via the output unit 52. In one example, the training plan generated by the plan determining module 68 trains the operator to maintain a predefined angle between the boom member 24 and the stick member 26 so that an unnecessary movement of the linkage system 16 may be reduced while performing the “Dumping operation”. However, if the operator fails to maintain the predefined angle between the boom member 24 and the stick member 26, the monitoring module 70 sends a visual message “Warning-Unnecessary linkage-Movement” to the output unit 52. In one example, details pertaining to the monitoring module 70 may be stored in the monitoring data 76. In one example, when the operation performed by the operator deviates from the training plan, the haptic device, such as a joystick may vibrate to wam the operator that operation is not being performed based on the training plan.

In another example, the identification module 66 identifies the value of the operation parameter and the operator attribute parameter as the “Loading operation” and “long load and carry”, respectively. Further, if the operational mode is selected as “fuel-efficiency mode”, then the plan determining module 68 may generate a training plan to train the operator to adapt the operating style of the operator as “tight V-pattern” instead of “long load and carry”, thereby reducing fuel consumption while performing the “Loading operation”.

The data received from the operation sensing unit 42, the operator attribute sensing unit 44, the environment sensing unit 46, and the operator interface 48, is analyzed near on-board the machine 10. For example, the data received from the operation sensing unit 42, the operator attribute sensing unit 44, and the environment sensing unit 46, are analyzed by using a remote device (not shown) that can be operated by the operator of the machine 10. In one example, the remote device may include any handheld device or portable device, such as, a mobile device, a laptop, and a tablet. In one example, the data received from the operation sensing unit 42, the operator attribute sensing unit 44, the environment sensing unit 46, and the operator interface 48, are analyzed on-board the machine 10. In another example, the data received from the operation sensing unit 42, the operator attribute sensing unit 44, the environment sensing unit 46, and the operator interface 48, are analyzed off-board the machine 10. In one example, the data received from the operation sensing unit 42, the operator attribute sensing unit 44, the environment sensing unit 46, and the operator interface 48, are analyzed by using fog Computing® in which a large amount of the data is transmitted to a handheld device and a small amount of the data is transmitted to a remote data center.

In one example, the processor 54 may be implemented as one or more microprocessors, microcomputers, microcontrollers, digital signal processors, central processing units, state machine, logic circuitries or any devices that manipulate signals based on operational instructions. Further, the interface 56 may include a variety of software and hardware interfaces. In another example, the interfaces 56 may include, but are not limited to, peripheral devices, such as a keyboard, a mouse, an external memory, and a printer. The interfaces 56 facilitate multiple communications within wide variety of protocols and networks, such as network, including wired network. The interfaces 56 may include one or more ports for connecting the controller 50 to a number of computing devices.

In one example, the memory 58 may include any non-transitory computer-readable medium known in the art. In one example, the non-transitory computer-readable medium may be a volatile memory, such as static random access memory and a non-volatile memory, such as read-only memory, erasable programmable ROM, and flash memory. Further, the training plan and the data associated with the monitoring of the operation can be stored in a data repository (not shown) that is remotely located, for the purpose of analyzing a performance of the operator over a span of time.

### Industrial Applicability

Referring to FIGS. 2 & 4, the operator training system 40 and a method 80 of the present disclosure generates a training plan for training the operator of the machine 10. The operator training system 40 can be coupled with any machine performing earthmoving operations. The operator training system 40 may generate the training plan in real-time considering real-time factors, such as the operation parameter, the operator attribute parameter, and the environmental parameter. Such parameters can be determined for any machine by installing various components of the operator training system 40 on the machine 10.

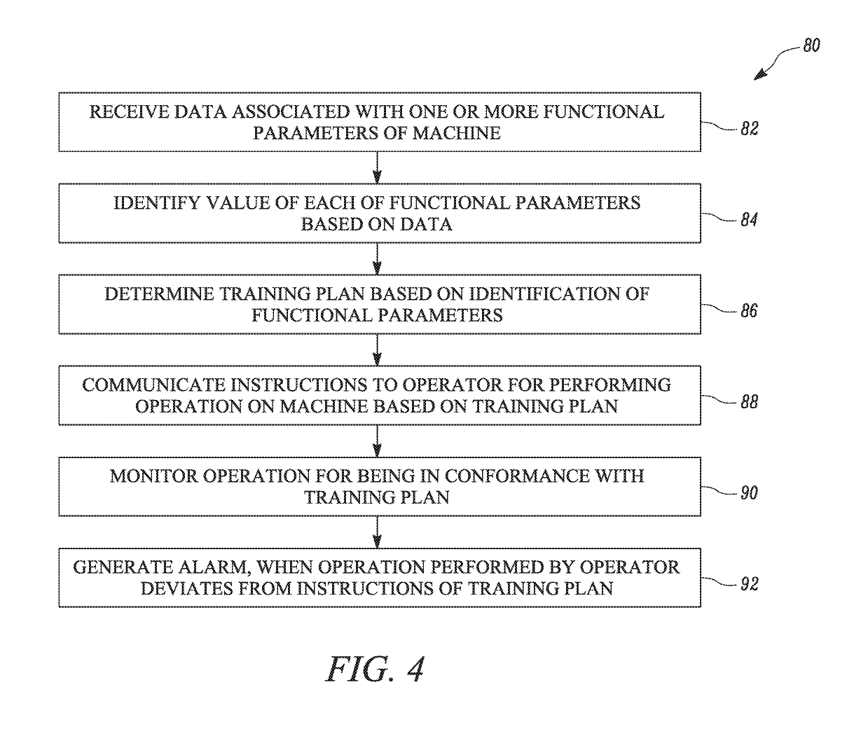

FIG. 4 is a flowchart depicting the method 80 for generating a training plan for training the operator of the machine 10. For the sake of brevity, some of the features of the present disclosure that are already explained in the description of FIG. 1 to FIG. 3 are not explained in detail in the description of FIG. 4. At step 82, the method 80 includes receiving, by the controller 50, data associated with one or more functional parameters of the machine 10. The functional parameters include at least one of the operation parameter, the operator attribute parameter, and the environmental parameter. In one example, the data receiving module 64 of the controller 50 may receive the data associated with the functional parameters of the machine 10.

At step 84, the method 80 includes identifying the value of each of the functional parameters based on the data received from the operation sensing unit 42, the operator attribute sensing unit 44, the environment sensing unit 46, and the operator interface 48. In one example, the value of the functional parameters may be identified at regular intervals for detecting a change in the functional parameters over time. In one example, the identification module 66 of the controller 50 may identify the value of the functional parameters. In one example, the identification module 66 may identify the value of the functional parameters at a predefined interval of time for detecting a change in the functional parameters.

At step 86, the method 80 includes determining the training plan in real-time based on the identification of the functional parameters. The controller 50 determines the training plan that includes one or more instructions for the operator to efficiently perform the operation. In one example, the plan determining module 68 of the controller 50 may determine the training plan in real-time.

At step 88, the method 80 includes communicating with the operator, via the output unit 52. The controller 50 communicates the instruction to the operator based on the training plan generated by the controller 50. The instructions may be visual instructions displayed on the output unit 52. In one example, the instructions may be audio instructions transmitted to the operator, via the audio device. In one example, the plan determining module 68 of the controller 50 may communicate the instructions to the operator based on the training plan.

At step 90, the method 80 includes monitoring the operation for being in conformance with the training plan. In one example, the monitoring module 70 of the controller 50 may monitor the operation. At step 92, the method 80 includes generating the alarm, when the operation performed by the operator deviates from the instructions of the training plan. In one example, the monitoring module 70 of the controller 50 may generate the alarm.

The operator training system 40 and the method 80 of the present disclosure can be implemented in any type of machine, such as excavators, wheel loaders, track-type tractors, motor graders, articulated trucks, pipe layers, and backhoes, without departing from the scope of the present disclosure. Therefore, the operator training system 40 and the method 80 are flexible in terms of installation and have a wide variety of application. The operator training system 40 and the method 80 consider various factors, such as weather conditions, an operational mode, and operator style in combination with the type of operation, for generating the training plan. As a result, the operator training system 40 and the method 80 offer a comprehensive approach for training the operator. Also, since the operator training system 40 is a closed loop and context-based system, the training plan keeps updating to accommodate any change in the functional parameters of the machine 10. Moreover, as the analysis can be performed in an on-board manner, an off-board manner, and a near on-board manner, the operation of the operating training system 40 becomes convenient. Therefore, the present disclosure offers the operator training system 40 and the method 80 that are simple, convenient, effective, easy to use, economical, and time saving.

While aspects of the present disclosure have been particularly shown and described with reference to the embodiments above, it will be understood by one skilled in the art that various additional embodiments may be contemplated by the modification of the disclosed remote operating station without departing from the spirit and scope of what is disclosed. Such embodiments should be understood to fall within the scope of the present disclosure as determined based upon the claims and any equivalents thereof.

What is claimed is:

1. A method for generating a training plan for an operator of a machine to perform an operation, the method comprising:
receiving, by a controller, data associated with one or more functional parameters of the machine, the functional parameters include at least one of an operation parameter, an operator attribute parameter, and an environmental parameter, wherein the operation parameter, the operator attribute parameter, and the environmental parameter are indicative of an identification of the operation to be performed and an operational mode of the machine, an operating style of the operator, and an environmental condition, respectively;
identifying, a value of each of the functional parameters based on the data;
determining, in real-time, the training plan based on the identification of the functional parameters, the training plan including instructions for the operator to perform the operation;
communicating the instructions to the operator for performing the operation on the machine based on the training plan;
monitoring the operation for being in conformance with the training plan; and
generating an alarm, when the operation performed by the operator deviates from the instructions of the training plan.
